(19) United States
(12) Patent Application Publication
(10) Pub. No.: US 2002/0128861 A1
(43) Pub. Date: Sep. 12, 2002

(54) Mapping clinical data with a health data dictionary

(76) Inventors: Lee Min Lau, Salt Lake City, UT (US); Joni D. Endo, Salt Lake City, UT (US); Steve Karren, Kaysville, UT (US); Michelle Willis, South Sandy, UT (US); Susan Harada, Salt Lake City, UT (US); Shane Beeney, Sandy, UT (US); Brian J. Larsen, Salt Lake City, UT (US); Edward M. Cassin, East Layton, UT (US); Martha Gerard, Salt Lake City, UT (US)

Correspondence Address: JOHN C. STRINGHAM, WORKMAN NYDEGGER & SEELEY, 1000 EAGLE GATE TOWER, 60 EAST SOUTH TEMPLE, SALT LAKE CITY, UT, 84111, US

(21) Appl. No.: 09/755,966

(22) Filed: Jan. 5, 2001

(51) Int. Cl. G06F 17/60

(52) U.S. Cl. 705/2

(57) ABSTRACT

Systems, methods, and computer program products for mapping clinical data including insurance data and pharmaceutical data with a health data dictionary. The health data dictionary provides a vocabulary that identifies insurance companies and pharmaceutical compounds including drugs in a normalized and standard form. The clinical data generated at a legacy system is compared with standard clinical data stored in the health data dictionary. Based on this comparison a partial or exact match is identified for the clinical data. After a match is selected, the normalized clinical data can be stored in a data repository. For unmatched clinical data, new concepts can be created and added to the health data dictionary for future use.

### BACKGROUND OF THE INVENTION

1. The Field of the Invention

The present invention relates to databases and to systems and methods for managing data in a database. More particularly, the present invention relates to systems and methods for managing data representations included in a health data dictionary database.

2. Description of Related Art

Computer based patient records (CPRs) are medical histories containing clinical data that can be stored and accessed electronically. Even though CPRs are accessible over computer systems and networks, the medical community is still faced with the problem of processing and evaluating CPRs because the clinical data is often not normalized and the CPRs may have different data formats. While electronically storing data is advantageous, storing data that is not normalized or properly arranged can introduce inconsistencies and incompatibilities that significantly limit the usability of databases storing CPRs.

The difficulties associated with processing and evaluating CPRs begin with the organization and accessibility of the clinical data stored in the CPRs, which is often provided by a variety of different sources, such as laboratory systems, pharmaceutical systems, and hospital information systems. Because the clinical data comes from diverse sources, it is not surprising that the clinical data exists in different formats. International Classification of Diseases (ICD), Systematized Nomenclature of Medicine (SNOMED), Systemized Nomenclature of Pathology (SNOP), commercial systems, and other proprietary formats are examples of systems or formats used when creating and storing medical records such as CPRs. Clinical data or CPRs are often accessed by clinicians, administrators, and researchers, as well as for other reasons including regulatory requirements and statistical studies. Accessing clinical data that is not normalized and that is stored in different formats or vocabularies makes the clinical data less usable. For these reasons, accessing clinical data can be a lengthy and unfruitful process.

In order to integrate and normalize the clinical data that is received from various legacy systems and in various vocabularies or formats, a data dictionary is needed to help translate and normalize the clinical data. The data dictionary is effectively a medical database that should have a defined, controlled vocabulary that is able to identify and represent unique items or concepts. The data dictionary should also have a data structure that describes the relationships between concepts such that significant medical descriptions and relationships can be produced. A data dictionary meeting these requirements would be able to translate and normalize medical data regardless of the source of the data and the format of the data.

While the attributes of an ideal data dictionary are identifiable, creating such a dictionary is much more problematic. A significant challenge is developing a vocabulary that is capable of handling both syntactic and semantic constructions. This is particularly important with regard to medical data, which is often expressed in natural language rather than numbers.

An early attempt to develop a data dictionary was through the use of structured text, which is still in use in many systems. Structured text relies on a model that defines the order in which data will appear. For example, a model laboratory result can be expressed as: [patient], [test], [result name], [result value], and [units]. Structured text works relatively well for predictable data, but has significant disadvantages. A system using structured text to store clinical data does not perform any evaluation on the clinical data that is stored. As a result, misspellings and incorrect entries can easily occur. In addition, any application that is designed to effectively access the structured text must be aware of all possible data variations. This limitation is extremely difficult to overcome because the dictionary storing the structured text as well as the applications, accessing the structured text must be modified every time new information, such as lab tests or new drugs, are added to the structured text. Structured text systems also have difficulty dealing with complex data, such as microbiology reports, and are not able to handle a controlled and standardized vocabulary that can be shared with other providers.

Another vocabulary used in data dictionaries is ICD, which emphasizes semantics. ICD uses a three digit number for representing the general concept, followed by a two digit number that represents a specific concept. While the ICD vocabulary facilitates data storage and retrieval, ICD is not adequate for representing the clinical information that is stored in data dictionaries and ultimately, in CPRs. For example, ICD cannot effectively represent time, which is a key element in many medical events. ICD also has the disadvantage of using a single code or concept to represent multiple events. For example, the ICD code of 100.89, “Other Leptospiral Infection,” is used for at least three fevers and three infections. For this reason, ICD introduces ambiguity that should be avoided in the context of a data dictionary.

SNOMED is a coding system or nomenclature that attends to both semantics and syntax. In fact, SNOMED III is a complete vocabulary that enables practitioners to describe a great number of concepts found in CPRs. SNOMED can describe anatomical and temporal concepts as well as probabilities. In spite of these strengths, however, SNOMED does not provide a syntax that is capable of reflecting complex relationships. SNOMED is a substantially complete list of terms that does not clarify the relationships that exist among those terms.

The information that is ultimately stored in a CPR extends beyond the medical realm to include information related to areas such as demographics and insurance. This type of information presents problems similar to the problems presented by medical vocabularies because different systems use different representations for a single concept. For example, the name of an insurance carrier can be represented in several different ways by different legacy systems. Mapping and matching insurance information is a difficult process and time consuming process. One problem caused by this delay is that an insurance company may be identified incorrectly. An incorrectly identified insurance company can have an effect, for example, on whether a service is properly billed.

A CPR also stores pharmaceutical information. Representing pharmaceutical information such as drugs in the data dictionary is a more difficult task because the number of different pharmaceutical compounds is extremely high. For each unique compound, there are other characteristics, such as dosage, that can vary. As a result, identifying this type of pharmaceutical information is a lengthy process. In addition, each drug can have multiple ingredients, each of which may vary in a particular compound. When a data dictionary receives this type of pharmaceutical information, matching and mapping the information to the data dictionary is a difficult manual process. A properly designed data dictionary, therefore can assist the storage of patient related data by providing a vocabulary for other data such as insurance and pharmaceutical data in addition to more strictly clinical data.

### SUMMARY OF THE INVENTION

These and other problems associated with related art are overcome by the present invention, which is directed towards automating the process of mapping and matching data to a database. More specifically, the present invention relates to systems and methods for mapping and matching insurance and pharmaceutical data to a health data dictionary. The inadequacies and shortcomings of previous vocabularies used in health data dictionaries are substantially overcome by the 3M® Healthcare Data Dictionary (HDD). In the HDD, each concept or item is uniquely defined and the HDD is able to incorporate other vocabularies such as ICD and SNOMED into the definitions and descriptions of the unique concepts. In addition, the HDD is able to establish complex relationships between different concepts, which permits meaningful medical expressions to be conveyed. The HDD, in addition to providing a vocabulary for medical data, also provides a vocabulary for other typed of data such as demographics, insurance data, pharmaceutical data, physical location data, and the like.

When a legacy system begins to utilize the HDD, the legacy system's data is first mapped to the HDD. This process often includes the creation of concepts and contexts for the legacy system. After the legacy system's initial data has been entered into the HDD, there is often a need to change how the data is represented. With regard to insurance information, the address of the insurance company represented in the health data dictionary may be incorrect. For example, the submitted data may have abbreviations and/or misspellings. Alternatively, the submitted insurance data may have a different format. The present invention provides an insurance manager that is used to normalize insurance data across all legacy systems.

The present invention also normalizes pharmaceutical information with a pharmacy manager The pharmacy manager is used to enter drugs according to their NDC and GCN codes. When drugs are mapped and matched to the health data dictionary, the strength and form of the drug as well as other characteristics such as delivery method and display name are used to properly map and match submitted pharmaceutical data. Mapping and matching data in this manner will assure that the data is ultimately stored in a normalized form that is useful not only to the submitting party, but also to outside parties such as researchers or administrators.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary system that provides a suitable operating environment for the present invention;

FIG. 2 is a block diagram illustrating the concepts, rules, and knowledge base within a health data dictionary;

FIG. 3 is a block diagram illustrating how data from legacy systems is translated by a health data dictionary and stored in a data repository; and

FIG. 4 is a block diagram illustrating a pharmacy manager and an insurance manager that interact with pharmaceutical and insurance content stored at the health data dictionary.

### DETAILED DESCRIPTION OF THE INVENTION

The present invention relates to systems and methods for translating clinical data and more specifically to mapping and matching insurance and pharmaceutical data. After the data has been mapped and matched, the data may be stored in a general data repository. The translation is aided by a health data dictionary (HDD) that contains concepts, each of which is a unique item or idea. The concepts are grouped according to contexts or domains and are used to translate clinical data. Each concept is associated with a representation that is often specific to a particular entity, although the representation can be used my many entities. The present invention allows the pharmaceutical and insurance content of the HDD to be created, modified, and deleted as described herein in more detail.

As used herein, clinical, medical or patient data refers to data that is associated with a patient and can include, but is not limited to, pharmaceutical data, laboratory results, diagnoses, symptoms, insurance data, personal information, demographic data, physical locations, beds, rooms, nursing divisions, facilities, buildings and the like. Generally, clinical data generated by a legacy system is stored in a general repository, which may be on-site or off-site. The general repository can also be specific to a particular legacy system or source or used by multiple legacy systems. Before the clinical data is stored in the general repository, it is transmitted through an interface engine to the HDD, where it is mapped, matched, and/or translated. Finally, the processed data is committed to the general repository. The HDD allows codes to be stored with the clinical data such that the clinical data can be consistently retrieved. The present invention therefore extends to both systems and methods for mapping, matching, and translating clinical data as well as to systems and methods for altering the HDD to reflect changes to concept representations and contexts. The embodiments of the present invention may comprise a special purpose or general purpose computer including various computer hardware, as discussed in greater detail below.

Embodiments within the scope of the present invention also include computer-readable media for carrying or having computer-executable instructions or data structures stored thereon. Such computer-readable media can be any available media which can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

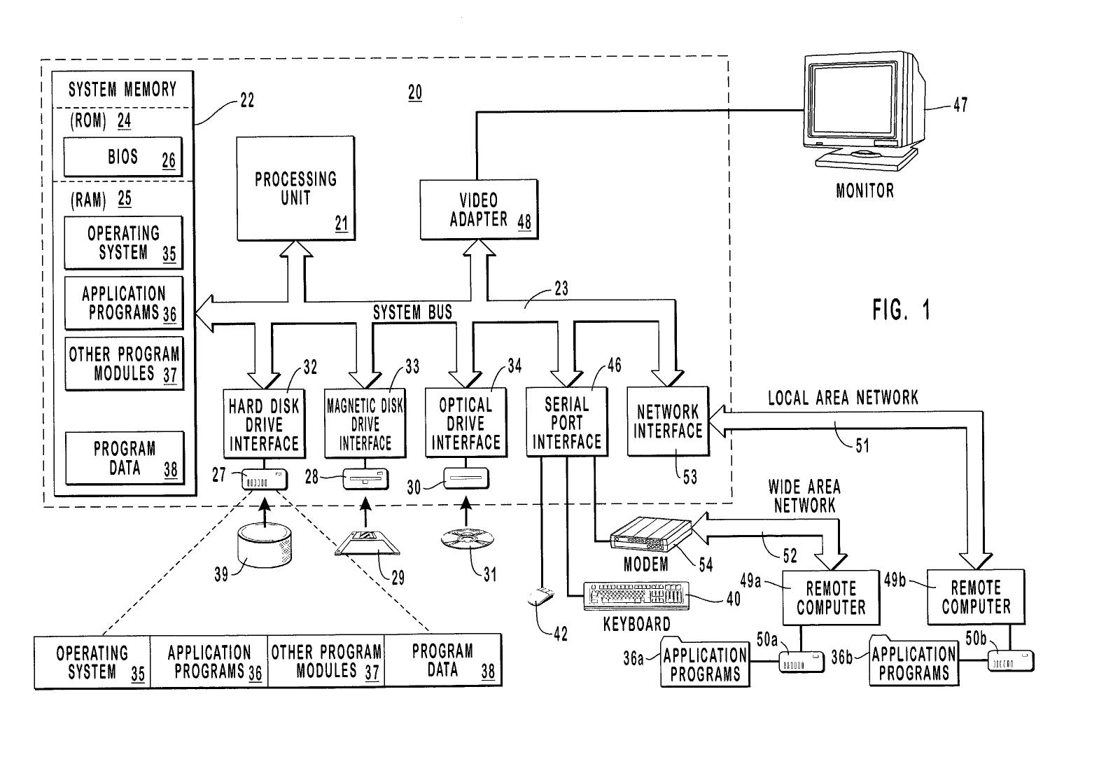

FIG. 1 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 1, an exemplary system for implementing the invention includes a general purpose computing device in the form of a conventional computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help transfer information between elements within the computer 20, such as during start-up, may be stored in ROM 24.

The computer 20 may also include a magnetic hard disk drive 27 for reading from and writing to a magnetic hard disk 39, a magnetic disk drive 28 for reading from or writing to a removable magnetic disk 29, and an optical disk drive 30 for reading from or writing to removable optical disk 31 such as a CD-ROM or other optical media. The magnetic hard disk drive 27, magnetic disk drive 28, and optical disk drive 30 are connected to the system bus 23 by a hard disk drive interface 32, a magnetic disk drive-interface 33, and an optical drive interface 34, respectively. The drives and their associated computer-readable media provide nonvolatile storage of computer-executable instructions, data structures, program modules and other data for the computer 20. Although the exemplary environment described herein employs a magnetic hard disk 39, a removable magnetic disk 29 and a removable optical disk 31, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 39, magnetic disk 29, optical disk 31, ROM 24 or RAM 25, including an operating system 35, one or more application programs 36, other program modules 37, and program data 38. A user may enter commands and information into the computer 20 through keyboard 40, pointing device 42, or other input devices (not shown), such as a microphone, joy stick, game pad, satellite dish, scanner, or the like. These and other input devices are often connected to the processing unit 21 through a serial port interface 46 coupled to system bus 23. Alternatively, the input devices may be connected by other interfaces, such as a parallel port, a game port or a universal serial bus (USB). A monitor 47 or another display device is also connected to system bus 23 via an interface, such as video adapter 48. In addition to the monitor, personal computers typically include other peripheral output devices (not shown), such as speakers and printers.

The computer 20 may operate in a networked environment using logical connections to one or more remote computers, such as remote computers 49a and 49b. Remote computers 49a and 49b may each be another personal computer, a server, a router, a network PC, a peer device or other common network node, and typically include many or all of the elements described above relative to the computer 20, although only memory storage devices 50a and 50b and their associated application programs 36a and 36b have been illustrated in FIG. 1. The logical connections depicted in FIG. 1 include a local area network (LAN) 51 and a wide area network (WAN) 52 that are presented here by way of example and not limitation. Such networking environments are commonplace in office-wide or enterprise-wide computer networks, intranets and the Internet.

When used in a LAN networking environment, the computer 20 is connected to the local network 51 through a network interface or adapter 53. When used in a WAN networking environment, the computer 20 may include a modem 54, a wireless link, or other means for establishing communications over the wide area network 52, such as the Internet. The modem 54, which may be internal or external, is connected to the system bus via the serial port interface 46. In a networked environment, program modules depicted relative to the computer 20, or portions thereof, may be stored in the remote memory storage device. It will be appreciated that the network connections shown are exemplary and other means of establishing communications over wide area network 52 may be used.

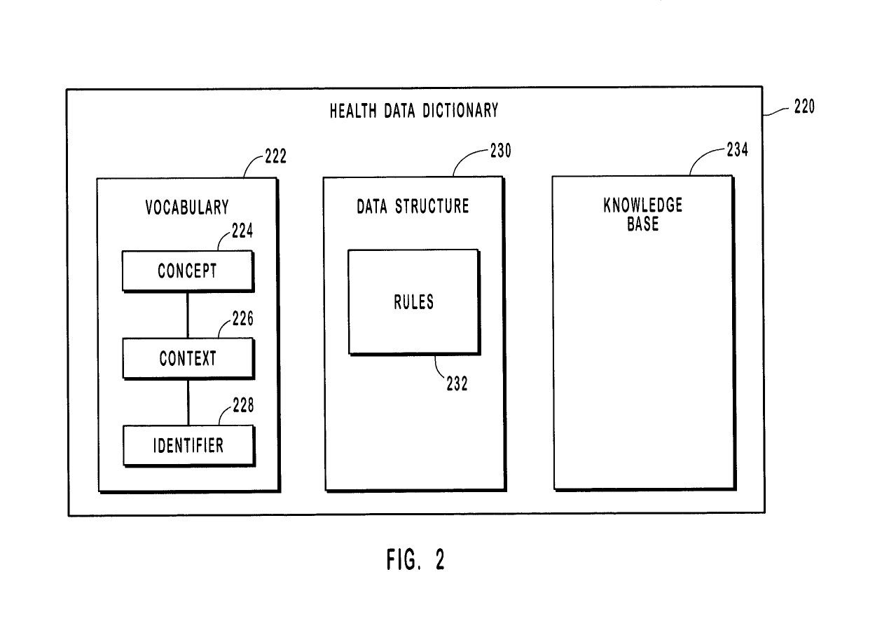

FIG. 2 is a block diagram that illustrates an exemplary health data dictionary (HDD). The HDD 220 describes clinical or medical data in all its possible forms, eliminates data ambiguity, and ensures that data is stored in an appropriate format or vocabulary. The HDD 220 is a database that is used to define or translate the clinical data stored in a computer based patient record (CPR). The HDD 220 ensures that patient data from multiple sources can be integrated and normalized into a form that is accessible by those sources. The HDD 220 integrates a controlled vocabulary, an information model that defines how medical concepts can be combined to produce medical descriptions, and a knowledge base that describes the complex relationships that may exist between the medical concepts.

The vocabulary 222 is designed to identify and uniquely represent concepts. Each concept 224 described within a particular context 226 is assigned a unique identifier 228. For example, the term or concept of “discharge” can occur in several different contexts: A patient can be discharged from a hospital; a surgeon can send a discharge from a wound to a laboratory; a chart can reflect that a discharge from a patient's ears has been occurring for a certain length of time; or a discharge code can be assigned to a particular case. Another example is the concept represented by the term “cold.” Cold can refer to body temperature, a feeling, or an upper respiratory infection.

The ambiguity created by these types of terms can be quickly and easily resolved by a care provider or other person because the context of the concept is readily apparent to the care provider. It is much more difficult, however, for computers to resolve these types of problems. The HDD 220 overcomes this problem with the vocabulary 222. The vocabulary 222 includes a concept 224, which is a unique, identifiable item or idea. Using the previous example, “cold” can be a concept. In order to make the cold concept unique, it is often provided in a context 226. As used herein, the combination of context and concept is referred to generally as a concept. If cold refers to an upper respiratory infection, then the context may be, for example, a diagnosis. This type of combination of a concept 224 and a context 226 results in unique identifiable items or ideas and each is assigned an identifier 228. Context can also be inferred from the legacy system that provided the clinical data. In the HDD 220, duplicate concepts or identifiers 228 are not allowed in order to maintain an accurate, controlled vocabulary 222. The HDD 220 is therefore capable of linking vague, ambiguous representations to precise definitions. The context 226 is often referred to as a domain. Examples of domains include, but are not limited to, insurances, diagnoses, symptoms, lab tests, lab results, drugs, and the like, In essence, the vocabulary 222 links surface forms or representations of concepts as they occur in medical language to unique, unambiguous concepts. For example, the representation of “common cold” and the representation of “URI” can both be related to the cold concept that is defined to be an upper respiratory infections. The vocabulary 222 incorporates many different types of surface forms or representations. For example, synonyms, homonyms, and eponyms are related to concepts in the HDD 220 and different representations of the same concept are related in the HDD 220. Thus, expressing a concept using either natural language or SNOMED will be connected to the same unique concept in the HDD 220. Common variants of a term including acronyms and misspellings are integrated into the vocabulary 222. Foreign language equivalents are included in the vocabulary 222 and specific contexts for certain terms are also reflected in the vocabulary. For instance, “dyspnea” may be a surface form for cardiologists while “shortness of breath” may be the preferred surface form for nursing station personnel.

The HDD 220 uses relationship tables to create these complex relationships. In one embodiment, the HDD 220 simply stores identifiers in the relationship tables, which are used to map or translate data as will be described in more detail below. The surface forms or representations are expressed in tables that effectively map surface forms to specific unique concepts. It is therefore possible for a surface form to be related to more than one concept. In this case, the context is useful in determining which concept is used as previously described.

The data structure 230 is a component of the HDD 220 that provides rules 232 to define how medical concepts are utilized. For example, the isolated concept of cold may be of little value. However, combining the cold concept with other concepts such as other symptoms, can result is a medical description. The concepts which represent symptoms can be combined to describe that a patient feels cold, nauseous, and feverish. In another example, the concepts of chest, x-ray and lung mass can be combined to describe that a chest x-ray shows a lung mass. The rules 232 ensure than meaningful medical descriptions are formed. In other words, concepts such as feverish cannot be combined with an x-ray because an x-ray cannot depict the feverish concept. The rules 232 can be altered as needed to ensure that accurate medical descriptions are obtained from the HDD 220.

The knowledge base 234 of the HDD 220 is used to describe the relationships that exist between the concepts in the HDD 220. For example, a lung mass bay be caused by lung cancer. In one embodiment of the HDD 220, the knowledge base 234 exists as related concept tables that link concepts together in defined relationships. The knowledge base 234 may use “is” and “has the components of” relationships to define the related concept tables. For example, the following table represents an exemplary portion of the knowledge base 234.

| Concept (Context) | Relationship | Concept |
|---|---|---|
| Temperature | Is | Cold |
| | | Hot |
| | | Tepid |
| Illness | Has the components of | Symptoms |
| | | Vital signs |
| | | Diagnosis |

Other types of relationships, such as “is a,” “caused by,” “related to,” “relieved by,” and the like can all be expressed and represented in the knowledge base 234. More generally, the HDD 220 is a collection of relationship tables that define concepts, establish relationships, and provide essential information necessary to translate, map and match clinical data contained in CPRs stored in a data repository. When clinical data has been translated and the unique identifiers describing that data are identified, the unique identifiers are often stored in the data repository such that the process can be reversed.

In order to maintain the integrity of the HDD, each different legacy system, organization, facility, or entity maintains a local copy of the HDD. A master version of the HDD is maintained at a different location and the copy of the HDD can be updated as needed. If necessary, changes made to the copy of the HDD can be uploaded to the master version of the HDD if necessary. In certain circumstances, the alteration made local copy of the HDD is not made to the master version of the HDD in order to preserve the integrity of the master version. In addition, many local changes are entity-specific and would have no meaning to other entities. For that reason, these types of changes to the HDD are not propagated. In other words, entities maintain copies of the HDD in part because much of the information maintained by the HDD, such as physical location data, is specific to a user and does not need to be stored in the master version of the HDD. If a particular concept is not found in the HDD, an error message is sent to the master HDD. The error message is reviewed and a new entry may be created in the HDD, depending on the analysis of the error message. If a new entry is created, the local copy of the HDD is updated such that the event that generated the error message no longer generates an error but is mapped to the HDD.

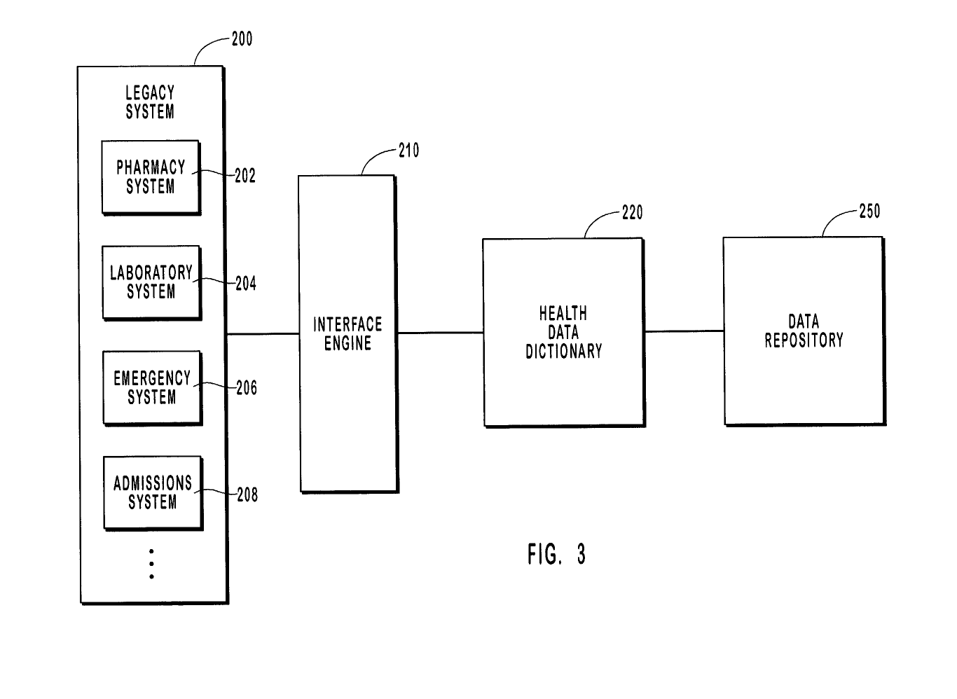

The formation of an extensive computer based patient record (CPR) can potentially involve many different health care providers. Each of these providers obtains different types of information from the patient whose clinical data is stored in the CPR. As previously described, the number of different care providers often causes problems with the CPR because the information gathered by those care providers is in different formats or vocabularies and is not normalized. FIG. 3 is a block diagram that illustrates an exemplary system that uses a health data dictionary to effectively create and store CPRs. The health data dictionary has the significant advantages of providing a data scheme that normalizes patient data and removes ambiguity, returns the patient data to care providers in the appropriate format, and describes medical data in all of its possible forms.

FIG. 3 illustrates a legacy system 200, which is representative of the sources of clinical data including facilities, enterprises, divisions within enterprises, and the like. Exemplary legacy systems include, but are not limited to, pharmacy system 202, laboratory system 204, emergency system 206, and admissions system 208. Each legacy system 200 is used to reflect patient data. The pharmacy system 202, for example, may reflect which drugs have been prescribed for a particular patient as well as the dosage. The laboratory system 204 may describe the results of tests that have been ordered for the patient. The emergency system 206 may reflect the symptoms of a patient as well as a possible diagnosis. The admissions system probably reflects patient data such as name, address, insurance carrier, and the like. In addition, the patient gathered by these legacy systems 200 may overlap in some instances. Other systems may also be used to gather patient information.

Each legacy system transmits data through an interface engine 210. In some instances, the interface engine 210 is not required because the legacy system is a direct client of the HDD. The interface engine 210 generates an interface code that is used when the HDD 220 processes the clinical data provided by the legacy system 200. For example, if the laboratory system 204 is sending data that identifies a patient's blood type from a blood test, then the interface code may be “blood type.” Note that while text is used in this discussion, the actual interface code is most likely a computer recognizable alphanumeric string. The HDD 220 receives the interface code, which is also a context, and is aware that the interface engine 210 associated with the laboratory system 204 sent the clinical data. Based on this context, the HDD 220 is able to use the interface code to find the concept identifiers that represent blood type. In this situation, more than one concept may be needed to accurately reflect the clinical data. A separate concept identifier may be needed, for example, to identify the test performed by the laboratory, the actual blood type, and the like. These concept identifiers are then stored in the data repository 250 along with information that identifies the patient. In this manner, the data repository 250 contains a patient's CPR in a standard and normalized form that is consistent with other information stored in the data repository 250 for that patient from other clinical data sources. The data repository 250 therefore contains a complete history of medical events associated with a particular person in a form that allows for efficient use by multiple parties. If the test is retrieved from the data repository 250, the HDD 220 can reverse the process to determine that a blood test was performed as well as provide the results of the blood test in the appropriate format or vocabulary. The HDD 220 therefore serves to translate clinical data into a standard and normalized format. Note that the combination of the unique concepts provides a meaningful medical description.

Depending on the information received by the HDD 220, the mapping and matching operations can be quite complex. While the blood test example provides a general overview of the process, the following discussion will focus on the actual details of mapping or matching insurance data and pharmaceutical data at the HDD.

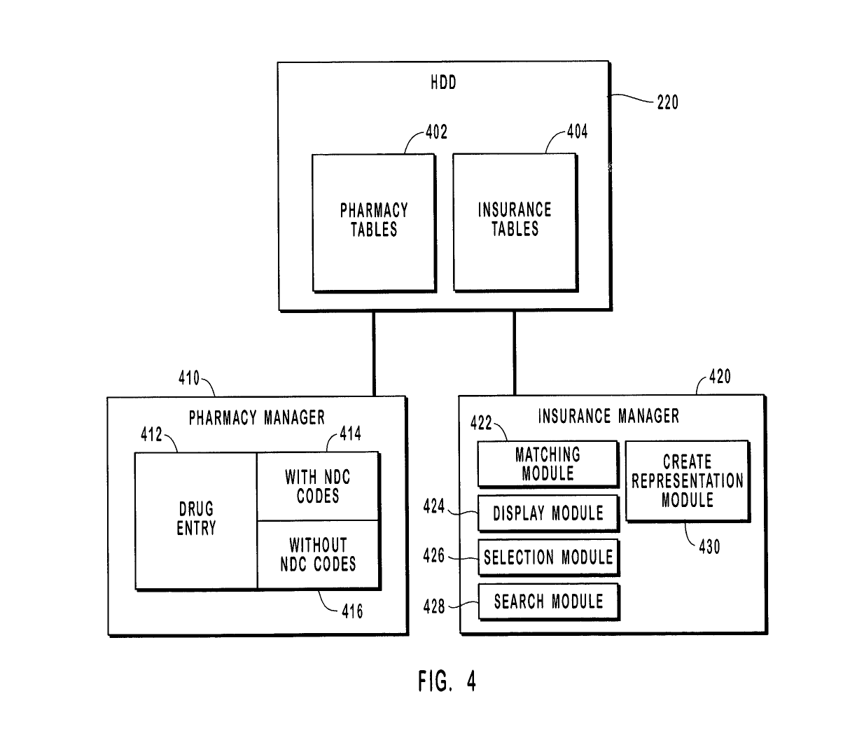

FIG. 4 is a block diagram illustrating an insurance manager and a pharmacy manager. Each manager has modules that allow the affected data to be efficiently created, modified or deleted. The insurance manager 420, for example, is used to map insurance companies and insurance plans to the HDD 220. The insurance data is maintained in the insurance tables 404 of the HDD 220. The modules provided by the insurance manager 420 facilitate matching and loading insurance data with the proper insurance data stored in the insurance tables 404 of the HDD 220. The insurance manager 420 can match insurance data exactly or partially and can match concepts one at a time or in batches. Before the insurance data can be matched, the HDD 220 needs to receive the insurance data from the legacy system. Receiving the insurance data from the legacy system, transmitting the insurance data from the legacy system to the HDD 220, and sending the insurance data are examples of steps for receiving the insurance information from the legacy system.

The matching module 422 provides the ability to compare insurance data submitted by a legacy system with proper insurance data stored in the HDD 220. This is necessary because the submitted insurance information does not always match the proper insurance information as previously mentioned. The HDD 220 provides, for example, synonym table that identify common variants of the name of an insurance company. If a legacy system is creating insurance information for a company called “Insurance Company,” but submits the value of “INS CO” to the HDD 220, then the synonym table will allow the matching module 422 to recognize that INS CO is often used to represent Insurance Company. The matching module 422 will therefore map the INS CO data to the proper value of Insurance Company. In a similar manner, the data submitted for addresses, cities, states, and zip codes will be matched by the matching module 422. Often, an exact match is not found in the HDD 220. In this case, the user is able to select the best match or create a new concept in the HDD 220 that represents the submitted insurance data. A significant advantage of the matching module 422 is that all insurance data is normalized after it is matched to the HDD. Matching the insurance data with the HDD 220 and comparing the insurance data with content of the HDD are examples of steps for changing the insurance information with the HDD.

The display module 424 enables a representation of a specific insurance concept to be displayed to a user. The selection module 426 warns a user that no match has been selected before a user proceeds to the next insurance record. The search module 428 allows the insurance concepts and representations in the HDD 220 to be searched. The create representation module 430 allows a new representation for an insurance concept to be created. The create representation module 430 also permits new concepts to be created using a format that is used to define an insurance concept. In this instance, a user will have to supply all information required by the HDD 220. Other modules, such as a module for altering a representation, can be included in the insurance manager 420. These modules facilitate the process of matching insurance information to the HDD 220. When the insurance manager 420 is operating, the rules and constraints of the HDD 220 are in effect such that the content of the HDD is not compromised and that all necessary relationships for the affected insurance data are maintained.

After the insurance information is properly matched or mapped, it is committed to a data repository along with identifiers from the HDD. Committing the normalized insurance information to the data repository in this manner is an example of a step for storing the normalized insurance information.

The pharmacy manager 410 facilitates adding content to the pharmacy domains represented in FIG. 4 as the pharmacy tables 402 of the HDD 220. The pharmacy manager 410 provides functionality similar to the insurance manager 420 with differences that are related to the pharmaceutical data operated on by the pharmacy manager 410. Pharmaceutical compounds and formulary items are difficult to match and map because of the number of different compounds. In the HDD 220, concepts are created for each local compound and the concepts include relationships between the ingredients of the compounds. As a result, the pharmacy manager 410 allows pharmaceutical data to be entered, matched or mapped, for example, by ingredient and by NDC code. The pharmacy manager 410 also allows for the alteration of representations of the pharmaceutical concepts as well as checking the entries for redundancy and completeness.

When a concept is being entered either as a single entry or as a batch entry, a user is prompted for certain information. A facility identifier is required, which identifies the legacy system. Comments can be provided as needed by the legacy system. For example, the name of the person submitting the pharmaceutical data can be provided in the comment field. A display name for the compound, a strength of the compound, an interface code for the compound, which will be provided by the legacy system through the interface engine, the form of the compound, and the route or method of administration of the compound are characteristics that are supplied by the legacy system. This information is input into the compound entry module 412 and entering or obtaining the characteristics of the pharmaceutical data in this manner is an example of a step for identifying characteristics of the pharmaceutical data.

The compound entry module 412 also provides two additional options for entering compound information. The compound can be entered with National Drug Code (NDC) codes (414) or without NDC codes (416). It is also possible to use Generic Sequence Number (GSN) numbers. When the NDC codes are supplied, the ingredients of the compound are related automatically. When NDC codes are not supplied, then a user is allowed to select concepts from a list. If all of the ingredients cannot be matched to the HDD 220, then the compound is submitted such that a new entry may be created for the HDD. The following table is an example of the information that is submitted by the legacy system through the pharmacy manager 410.

| | Drug | | | | Interface | Ingredient | | |
|---|---|---|---|---|---|---|---|---|
| C.NCID | Name | Strength | Form | Route | Code | NCID | Definition | Comment |

| | | | | | | |
|---|---|---|---|---|---|---|
| NEW1 | Ex1 | 200 mg | Tablet | Oral | 111 | NCID A |
| NEW1 | | | | | | NCID B |
| NEW1 | | | | | | NCID C |
| NEW2 | Ex2 | 100 mg | liquid | Oral | 222 | NCID A |
| NEW2 | | | | | | NCID B |

The C.NCID column and the Ingredient NCID columns are unique identifiers. The information in the submitted table can be compared with the information in the pharmacy tables 402 to match a submitted compound quickly and easily and matching a compound in this manner is an example of comparing the pharmaceutical characteristics of the submitted pharmaceutical data with standardized characteristics of the pharmaceutical data. The pharmacy manager 410 is able to create new relationships as well as handle new concepts with new representations.

The pharmacy manager 410 allows each pharmaceutical concept to include each ingredient and its associated NDC and GSN numbers. In this manner, a concept added by the pharmacy manager 410 actually represents each of the individual ingredients of the compound that corresponds to the concept. The pharmacy manager 410 also allows the representation of that concept to be altered. For example, some medical providers may develop an ointment that includes one or more ingredients. The ointment may be added to the local copy of the HDD 220 and in the pharmacy tables 402, the ingredients of the ointment are associated and defined. The ointment has a representation, which is also reflected in the pharmacy tables 420 of the HDD 220. The legacy system can, through the pharmacy manager 402, change the representation of the ointment as desired. This is advantageous, for example, when the ointment is frequently used. A user of the legacy system can input the representation of the ointment, which is understood by the users of the legacy system. However, the HDD maps the ointment to its ingredients, NDC codes, and GSN numbers, which are ultimately stored in the data repository. Thus, accessing the data is not confusing because all ingredients are known and stored in a normalized fashion.

More generally, the insurance manager 410 and the pharmacy manager 420 make the process of mapping and matching insurance and pharmaceutical data quicker and more efficient. In addition, the HDD 220 allows the insurance and pharmaceutical data to be normalized and standardized. The insurance manager and the pharmacy manager substantially automate the process of mapping, matching, loading, and translating insurance data and pharmaceutical data.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. In a system including a legacy system having clinical information, wherein the clinical information is stored in a data repository, wherein the clinical information is not normalized and not in a standard format, a method for mapping the clinical information to a health data dictionary such that the clinical information is normalized and in a standard format, the method comprising:
an act of receiving insurance information from the legacy system;
an act of searching content of the health data dictionary for a match to the received insurance information; and
an act of identifying a match for the insurance information.

2. A method as defined in claim 1, further comprising an act of identifying a best match for the insurance information when the match is a partial match.

3. A method as defined in claim 1, further comprising an act of displaying insurance concepts to a user.

4. A method as defined in claim 1, further comprising an act of creating a new insurance concept when the match is not found.

5. A method as defined in claim 1, further comprising an act of creating a new representation for an existing insurance concept stored in the health data dictionary.

6. A method as defined in claim 1, wherein the act of searching content of the health data dictionary further comprises as act of comparing the insurance information with insurance tables in the health data dictionary.

7. A method as defined in claim 6, wherein the insurance tables include synonym tables, the synonym tables including at least one of misspellings of insurance data, abbreviations of insurance data, spellings of insurance data, and formats of insurance data.

8. In a system including a legacy system storing insurance information in a data repository, wherein the insurance information is not normalized and is not in a standard form, a method for mapping the insurance information to a normalized and standard form, the method comprising:
a step for receiving the insurance information from the legacy system;
a step for changing the insurance information using existing content of a health data dictionary, wherein the content of the health data dictionary includes standard insurance information associated with concept identifiers; and
a step for storing the changed insurance information in the data repository with the concept identifiers that correspond to the changed insurance information.

9. A method as defined in claim 8, wherein the step for changing the insurance information further comprises a step for searching the standard insurance information, wherein the standard insurance information is stored in insurance tables of the health data dictionary.

10. A method as defined in claim 8, wherein the step for changing the insurance information further comprises a step for identifying a match for the insurance information.

11. A method as defined in claim 10, wherein the match is an exact match.

12. A method as defined in claim 10, wherein the match is a partial match, wherein the partial match is identified according to a probability.

13. A method as defined in claim 10, further comprising a step for selecting a best match for the insurance information.

14. A method as defined in claim 8, wherein the step for changing the insurance information further comprises:
a step for comparing the insurance information with synonym tables included in the insurance tables of the health data dictionaries, the synonym tables including misspellings of the insurance data, abbreviations of the insurance data and different formats of the insurance data; and
a step for correcting the insurance information to the standard insurance information identified by the match.

15. In a system including a legacy system having clinical data including pharmaceutical data, wherein the pharmaceutical data is not normalized and is not in a standard format, a method for mapping the pharmaceutical data to a health data dictionary, wherein the health data dictionary has content including pharmaceutical content in a standard form, the method comprising:
an act of receiving the pharmaceutical data from the legacy system, wherein the pharmaceutical data has characteristics including a name, a strength, a form, a route, an interface code, and ingredient information, wherein the characteristics identify a compound;
and act of searching the health data dictionary according to the characteristics of the compound; and
an act of selecting a match for the compound such that the compound is in the standard form.

16. A method as defined in claim 15, wherein the act of receiving the pharmaceutical data further comprises an act of receiving national drug codes for the ingredients.

17. A method as defined in claim 15, wherein the act of receiving the pharmaceutical data further comprises an act of receiving generic sequence numbers for the compound.

18. A method as defined in claim 15, wherein the act of searching the health data dictionary further comprises an act of comparing the characteristics of the compound to standard characteristics of a standard compound stored in pharmacy tables of the health data dictionary.

19. A method as defined in claim 18, wherein the match is an exact match with a standard compound.

20. A method as defined in claim 18, wherein the match is a partial match with a standard compound.

21. A method as defined in claim 20, further comprising an act of creating a new pharmacy entry in the pharmacy tables of the health data dictionary for an unmatched compound.

22. A method as defined in claim 15, further comprising an act of providing a list of ingredients to select from when the national drug codes are not provided.

23. In a system including a legacy system sending clinical data including pharmaceutical data to a data repository for storage, wherein the clinical data is not in a standard format and is not normalized, a method for mapping the clinical data such that the clinical data is normalized with a health data dictionary, the method comprising:
a step for identifying characteristics of the pharmaceutical data at the legacy system, wherein the characteristics include a drug name, a strength, a form, an interface code, and one or more ingredient identifiers.
a step for comparing the characteristics of the pharmaceutical data with standard characteristics standard characteristics of the pharmaceutical data, the standard characteristics stored in pharmacy tables of the health data dictionary; and
a step for selecting a match for the pharmaceutical data provided by the legacy system such that the pharmaceutical data is normalized.

24. A method as defined in claim 23, wherein the step for identifying characteristics further comprises a step for identifying a route for the pharmaceutical data.

25. A method as defined in claim 23, wherein the step for selecting a match further comprises a step for selecting an exact match.

26. A method as defined in claim 23, wherein the step for selecting a match further comprises a step for identifying a partial match for the pharmaceutical data.

27. A method as defined in claim 23, wherein the step for identifying characteristics further comprises a step for identifying national drug codes for the ingredients.

28. A method as defined in claim 23, wherein the step for identifying characteristics further comprises a step for identifying generic sequence numbers for the pharmaceutical data.

29. A method as defined in claim 23, further comprising a step for inserting a representation for the pharmaceutical data in the health data dictionary.

30. A method as defined in claim 23, further comprising a step for enforcing rules and constraints of the health data dictionary.

31. A method as defined in claim 23, further comprising a step for modifying a pharmaceutical concept without the national drug code.

32. In a computerized system that includes a legacy system, a health data dictionary, and a data repository, wherein the legacy system provides clinical data for storage in the data repository and wherein the clinical data is not normalized, a computer program product for implementing a method of mapping the clinical data with the health data dictionary to normalize the clinical data before storing the clinical data in the data repository, the computer program product comprising:
a computer readable medium for carrying machine-executable instructions for implementing the method, wherein the method is comprised of machine-executable instructions for performing:
an act of receiving insurance information from the legacy system;
an act of searching content of the health data dictionary for a match to the received insurance information; and
an act of identifying a match for the insurance information.

33. In a computerized system that includes a legacy system, a health data dictionary, and a data repository, wherein the legacy system provides clinical data for storage in the data repository and wherein the clinical data is not normalized, a computer program product for implementing a method of mapping the clinical data with the health data dictionary to normalize the clinical data before storing the clinical data in the data repository, the computer program product comprising:
a computer readable medium for carrying machine-executable instructions for implementing the method, wherein the method is comprised of machine-executable instructions for performing:
an act of receiving the pharmaceutical data from the legacy system, wherein the pharmaceutical data has characteristics including a name, a strength, a form, a route, an interface code, and ingredient information, wherein the characteristics identify a compound;
and act of searching the health data dictionary according to the characteristics of the compound; and
an act of selecting a match for the compound such that the compound is in the standard form.
